(19) United States
(12) Patent Application Publication
(10) Pub. No.: US 2026/0237083 A1
(43) Pub. Date: Aug. 13, 2026

(54) ESTIMATION APPARATUS, ESTIMATION METHOD, AND NON-TRANSITORY COMPUTER-READABLE MEDIUM

(71) Applicant: NEC Corporation, Tokyo (JP)

(72) Inventors: Noboru YOSHIDA, Tokyo (JP); Atsushi HONDA, Tokyo (JP); Yoshihiro KAJIKI, Tokyo (JP); Takayuki KASE, Tokyo (JP); Ikumu YASUDA, Tokyo (JP); Takumi OZAKI, Tokyo (JP); Jianquan LIU, Tokyo (JP); Tingting DONG, Tokyo (JP)

(73) Assignee: NEC Corporation, Tokyo (JP)

(21) Appl. No.: 19/156,997

(22) PCT Filed: Jan. 18, 2024
(86) PCT No.: PCT/JP2024/001231

§ 371 Date: Aug. 15, 2025

(30) Foreign Application Priority Data
Mar. 16, 2023 (JP) 2023-041791

(51) Int. Cl. G06T 7/292; G06V 10/62; G06V 20/52; G06V 40/10

(52) U.S. Cl. CPC G06T 7/292; G06V 10/62; G06V 20/52; G06V 40/10; G06T 2207/30196; G06T 2207/30232

(57) ABSTRACT

The present invention provides an estimation device comprising: a person detection unit that detects a person to be tracked from within an image generated by a plurality of cameras installed at prescribed positions; a camera identification unit that identifies a camera for which the timing at which the person to be tracked is detected in the image satisfies a prescribed condition that is based on a target time; and an estimation unit that, on the basis of the installation position of the identified camera, estimates an area in which the person to be tracked is present at the target time.

### TECHNICAL FIELD

The present invention relates to an estimation device, an estimation method, and a program.

### BACKGROUND ART

A technique related to the present invention is disclosed in PTL 1. The technique disclosed in PTL 1 discloses a technique for tracking a person to be tracked based on images generated by a plurality of cameras.

### CITATION LIST

### Patent Literature

PTL 1: WO 2020/115890 A1

### SUMMARY OF INVENTION

### Technical Problem

By using the tracking technique as disclosed in PTL 1, it is possible to specify the position where the person to be tracked is present at the target time. However, in the case of the tracking technique, in a case where the person to be tracked is not shown in the image photographed at the target time, the position where the person to be tracked is present at the target time cannot be specified.

In view of the above problem, an object of the present invention is to provide an estimation device, an estimation method, and a program for estimating an area where a person to be tracked is present at a target time.

### Solution to Problem

According to one aspect of the present invention, there is provided an estimation device including:
a person detection means for detecting a person to be tracked from among images generated by a plurality of cameras installed at predetermined positions;
a camera identification means for specifying the camera in which a timing at which the person to be tracked is detected in the image satisfies a predetermined condition based on a target time; and
an estimation means for estimating an area where the person to be tracked is present at the target time based on a specified installation position of the camera.

According to one aspect of the present invention, there is provided an estimation method for causing one or more computers to execute:
detecting a person to be tracked from among images generated by a plurality of cameras installed at predetermined positions;
specifying the camera in which a timing at which the person to be tracked is detected in the image satisfies a predetermined condition based on a target time; and
estimating an area where the person to be tracked is present at the target time based on a specified installation position of the camera.

According to one aspect of the present invention, there is provided a recording medium having recorded therein a program for causing a computer to function as:
a person detection means for detecting a person to be tracked from among images generated by a plurality of cameras installed at predetermined positions;
a camera identification means for specifying the camera in which a timing at which the person to be tracked is detected in the image satisfies a predetermined condition based on a target time; and
an estimation means for estimating an area where the person to be tracked is present at the target time based on a specified installation position of the camera.

### ADVANTAGEOUS EFFECTS OF INVENTION

According to one aspect of the present invention, an estimation device, an estimation method, and a program for estimating an area in which a person to be tracked is present at a target time are implemented.

### BRIEF DESCRIPTION OF DRAWINGS

The above-described object and other objects, features, and advantages will be further clarified by the following suitable example embodiments and accompanying drawings.

FIG. 1 It is a diagram illustrating an example of a functional block diagram of an estimation

FIG. 2 It is a diagram illustrating an example of a hardware configuration of the estimation device.

FIG. 3 It is a diagram for explaining an example of processing in which the estimation device estimates a predetermined area.

FIG. 4 It is a diagram for explaining another example of processing of estimating a predetermined area by the estimation device.

FIG. 5 It is a diagram for explaining another example of processing of estimating a predetermined area by the estimation device.

FIG. 6 It is a flowchart illustrating an example of a flow of processing of the estimation device.

FIG. 7 It is a diagram for explaining an example of processing in which the estimation device estimates a visit target of a person to be tracked.

FIG. 8 It is a flowchart illustrating an example of a flow of processing of the estimation device.

FIG. 9 It is a diagram illustrating an example of information output by the estimation device.

### EXAMPLE EMBODIMENT

Hereinafter, example embodiments of the present invention will be described with reference to the drawings. In all the drawings, similar components are denoted by similar reference numerals, and the description thereof will be omitted as appropriate.

### First Example Embodiment

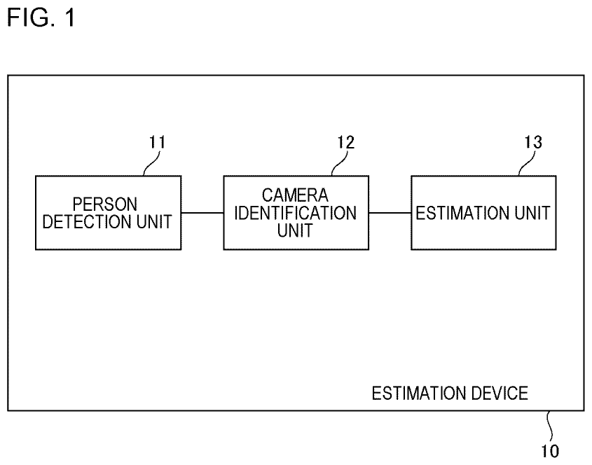

FIG. 1 is a functional block diagram illustrating an outline of an estimation device 10 according to a first example embodiment. The estimation device 10 includes a person detection unit 11, a camera identification unit 12, and an estimation unit 13.

The person detection unit 11 detects a person to be tracked from among images generated by a plurality of cameras installed at predetermined positions. The camera identification unit 12 specifies a camera in which the timing at which the person to be tracked is detected in the image satisfies a predetermined condition based on the target time. The estimation unit 13 estimates an area in which the person to be tracked is present at the target time based on the specified installation position of the camera.

As described above, the estimation device 10 of the present example embodiment specifies a camera in which the timing at which the person to be tracked is detected in the image satisfies the predetermined condition based on the target time, and estimates the area in which the person to be tracked is present at the target time based on the installation position of the specified camera. According to the estimation device 10 of the present example embodiment, it is possible to estimate the area in which the person to be tracked is present at the target time with high accuracy.

### Second Example Embodiment

### “Outline”

An estimation device 10 of a second example embodiment is a more specific version of the estimation device 10 of the first example embodiment. That is, the estimation device 10 specifies a camera in which the timing at which the person to be tracked is detected in the image satisfies the predetermined condition based on the target time, and estimates the area in which the person to be tracked is present at the target time based on the installation position of the specified camera. Details will be described below.

### “Hardware Configuration”

An example of a hardware configuration of the estimation device 10 will be described. Each functional unit of the estimation device 10 is implemented by any combination of hardware and software. It is to be understood by those skilled in the art that there are various modifications of the implementation method and the device. The software includes a program stored in advance from the stage of shipping the device, a program downloaded from a recording medium such as a compact disc (CD) or a server on the Internet, and the like.

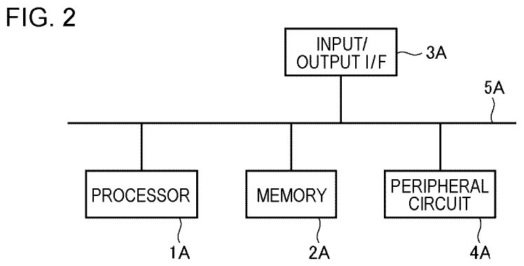

FIG. 2 is a block diagram illustrating the hardware configuration of the estimation device 10. As illustrated in FIG. 2, the estimation device 10 includes a processor 1A, a memory 2A, an input/output interface 3A, a peripheral circuit 4A, and a bus 5A. The peripheral circuit 4A includes various modules. The estimation device 10 may not include the peripheral circuit 4A. The estimation device 10 may include a plurality of physically and/or logically separated devices. In this case, each of the plurality of devices can have the above-described hardware configuration.

The bus 5A is a data transmission path through which the processor 1A, the memory 2A, the peripheral circuit 4A, and the input/output interface 3A mutually transmit and receive data. The processor 1A is, for example, an arithmetic processing unit such as a CPU or a graphics processing unit (GPU). The memory 2A is, for example, a memory such as a random access memory (RAM) or a read only memory (ROM). The input/output interface 3A includes an interface for acquiring information from an input device, an external device, an external server, an external sensor, a camera, and the like and an interface for outputting information to an output device, an external device, an external server, and the like. The input/output interface 3A includes an interface for connecting to a communication network such as the Internet. The input device is, for example, a keyboard, a mouse, a microphone, a physical button, a touch panel, or the like. The output device is, for example, a display, a speaker, a printer, a mailer, or the like. The processor 1A can issue a command to each module and perform calculation based on the calculation results.

### “Functional Configuration”

Next, a functional configuration of the estimation device 10 of the present example embodiment will be described in detail. FIG. 1 illustrates an example of a functional block diagram of the estimation device 10 according to the present example embodiment. As illustrated, the estimation device 10 of the present example embodiment includes a person detection unit 11, a camera identification unit 12, and an estimation unit 13.

The person detection unit 11 detects a person to be tracked from among images generated by a plurality of cameras installed at predetermined positions.

The “image” is a concept including a moving image.

A “camera” captures an image. The camera may be a monitoring camera. The camera is installed at a predetermined position and captures an image around the position. The installation position of the camera is not particularly limited. The camera may be installed on a road or may be installed in a facility. Examples of the facility include a department store, a museum, and an art gallery, but are not limited thereto. The camera may be installed outdoors or indoors. Information indicating the installation position of each of the plurality of cameras is registered in the estimation device 10 in advance. The installation position of the camera may be indicated by latitude and longitude, or may be indicated by an address. In the case of a camera installed in a facility, the installation position of the camera may be indicated by position information specific to the facility, such as a passage number or a room number.

Such images generated by each of the plurality of cameras are input to the estimation device 10 by an arbitrary means. For example, the estimation device 10 and the camera may be communicably connected. Then, the camera may transmit the generated image to the estimation device 10. In addition, the image generated by the camera may be accumulated in an arbitrary storage means. Then, the image stored in the storage means may be input to the estimation device 10 by a manual operation by the user. The image input to the estimation device 10 may be performed by real-time processing or batch processing. The person detection unit 11 can acquire the image input to the estimation device 10 in this manner. The person detection unit 11 may acquire the image by other means.

The “acquisition” includes at least one of an own device going to obtain data or information stored in another device or a storage medium (active acquisition) and an own device receiving data or information output from another device (passive acquisition). Examples of the active acquisition include requesting or inquiring another device and receiving a reply thereto and accessing and reading another device or a storage medium. Examples of passive acquisition include reception of information to be distributed (alternatively, transmission, push notification, and the like). Further, “acquisition” may be selecting and acquiring from among received data or information or selecting and receiving distributed data or information.

The person detection unit 11 detects a person to be tracked from the images acquired in this manner. The person detection unit 11 detects the person to be tracked from the image based on the information indicating the feature amount of the appearance of the person to be tracked.

The “information indicating the feature amount of the appearance of the person to be tracked” is input to the estimation device 10 by the user. For example, the user may input the feature amount of the appearance of the person to be tracked to the estimation device 10. In addition, the user may input the image of the person to be tracked to the estimation device 10.

Then, the person detection unit 11 may analyze the image and extract the feature amount of the appearance of the person to be tracked.

The “feature amount of the appearance of the person to be tracked” includes, but is not limited to, a feature amount of a face, a feature amount of a body, a feature amount of clothing, a feature amount of belongings, a feature amount of shoes, and the like.

The person detection unit 11 detects the person to be tracked from the images of the plurality of cameras based on the feature amount of the appearance of the person to be tracked. Then, the person detection unit 11 can record the detection result in the detection history. The detection history indicates a timing at which the person to be tracked is detected for each camera. The timing at which the person to be tracked is detected is the photographing date and time of the frame image in which the person to be tracked is detected. The person detection unit 11 can specify the photographing date and time of the frame image in which the person to be tracked is detected based on the time stamp added to the image.

The camera identification unit 12 specifies a camera in which the timing at which the person to be tracked is detected in the image satisfies a predetermined condition. The predetermined condition is defined based on the target time. The camera identification unit 12 can specify a camera satisfying a predetermined condition based on the detection history described above, for example.

The “target time” is a timing for estimating an area where the person to be tracked is present. That is, the estimation device 10 estimates the area where the person to be tracked is present at the target time. The target time is a current time or a current, future, or past time designated by the user. For example, the current time may be automatically set as the target time. In addition, the target time may be set by user input. The user can set any time in the current, future, or past as the target time.

The “predetermined condition” can include at least one of the following Conditions 1 to 4.

(Condition 1) A person to be tracked is detected at a timing closest to the target time among the plurality of cameras.

(Condition 2) A person to be tracked is detected at a timing closest to the target time among the plurality of cameras before the target time.

(Condition 3) A person to be tracked is detected at a timing closest to the target time among the plurality of cameras after the target time.

(Condition 4) A person to be tracked is detected within a reference time from a target time.

In a case where Condition 1 is a predetermined condition, the camera identification unit 12 specifies a camera in which the person to be tracked is detected at a timing closest to the target time from among the plurality of cameras. The detection timing may be before or after the target time.

In a case where Condition 2 is a predetermined condition, the camera identification unit 12 specifies, from among the plurality of cameras, a camera in which the person to be tracked is detected at a timing closest to the target time before the target time.

In a case where Condition 3 is a predetermined condition, the camera identification unit 12 specifies, from among the plurality of cameras, a camera in which the person to be tracked is detected at a timing closest to the target time after the target time.

In a case where Condition 4 is a predetermined condition, the camera identification unit 12 specifies a camera in which the person to be tracked is detected within the reference time from the target time from among the plurality of cameras. The detection timing may be before or after the target time. In a case where Condition 4 is a predetermined condition, the number of cameras specified by the camera identification unit 12 varies.

A condition in which a plurality of Conditions 1 to 4 are connected under an AND condition or an OR condition may be set as a predetermined condition.

For example, Condition 1 and Condition 4 may be a predetermined condition. In this case, the camera identification unit 12 specifies, from among the plurality of cameras, a camera in which the person to be tracked is detected within the reference time from the target time and the person to be tracked is detected at a timing closest to the target time. The detection timing may be before or after the target time.

In addition, Condition 2 and Condition 4 may be a predetermined condition. In this case, the camera identification unit 12 specifies, from among the plurality of cameras, a camera in which the person to be tracked is detected within the reference time from the target time and the person to be tracked is detected at a timing closest to the target time before the target time.

In addition, Condition 3 and Condition 4 may be a predetermined condition. In this case, the camera identification unit 12 specifies, from among the plurality of cameras, a camera in which the person to be tracked is detected within the reference time from the target time and the person to be tracked is detected at a timing closest to the target time after the target time.

In addition, Condition 2 or Condition 3 may be a predetermined condition. In this case, the camera identification unit 12 specifies, from among the plurality of cameras, both a camera in which the person to be tracked is detected at a timing closest to the target time before the target time and a camera in which the person to be tracked is detected at a timing closest to the target time after the target time. Condition 4 may be combined with Condition 2 or Condition 3 under an AND condition. It is conceivable that Condition 2 or Condition 3 or a predetermined condition obtained by combining Condition 4 with Condition 2 or Condition 3 by an AND condition is used, for example, in a case where the target time is a past time.

The estimation unit 13 estimates an area in which the person to be tracked is present at the target time based on the installation position of the camera specified by the camera identification unit 12. The estimation unit 13 can execute at least one of the following first to third area estimation processing.

### First Area Estimation Processing

The first area estimation processing is suitable for use in a case where one camera is specified by the camera identification unit 12.

First, the estimation unit 13 calculates a moving time which is a time difference between the latest detection timing at which the person to be tracked is detected in the image generated by the camera specified by the camera identification unit 12 and the target time.

The “latest detection timing” is a timing closest to the target time among timings at which the person to be tracked is detected in the image generated by the camera specified by the camera identification unit 12. In a case where the camera is specified as a camera that satisfies the above Condition 2, the latest detection timing is a timing before the target time and closest to the target time among the timings at which the person to be tracked is detected in the image generated by the camera. In a case where the camera is specified as a camera that satisfies the above Condition 3, the latest detection timing is a timing after the target time and closest to the target time among the timings at which the person to be tracked is detected in the image generated by the camera.

The estimation unit 13 determines the estimated moving speed of the person to be tracked. Here, processing of calculating the estimated moving speed will be described. The estimation unit 13 determines the estimated moving speed based on the characteristic of the person to be tracked acquired by the user input or the analysis of the image generated by the camera. The characteristics of the person to be tracked include at least one of an age, a sex, presence or absence of baggage, a size of baggage, presence or absence of injury, a movement means (walk, bicycle, motorcycle, motor vehicle, etc.), and a moving speed in the image of the person to be tracked.

The estimation unit 13 can calculate the estimated moving speed of the person to be tracked based on the person characteristic information, for example. A speed calculation model is generated in advance in which the person characteristic information is input and the estimated moving speed calculated based on the input person characteristic information is output. The speed calculation model may be a function, a learning model generated by machine learning, or other models. The estimation unit 13 inputs the person characteristic information of the person to be tracked to such a speed calculation model, and acquires the estimated moving speed output from the speed calculation model.

In addition, the estimation unit 13 may calculate the moving speed of the person to be tracked in the image based on the image and set the calculation result as the estimated moving speed of the person to be tracked. The calculation of the moving speed of the person detected in the image can be achieved using any technique.

After calculating the moving time and the estimated moving speed, the estimation unit 13 calculates the estimated moving distance of the person to be tracked between the latest detection timing and the target time based on the moving time and the estimated moving speed. The estimated moving distance can be simply obtained as a product of the moving time and the estimated moving speed, but other methods may be adopted.

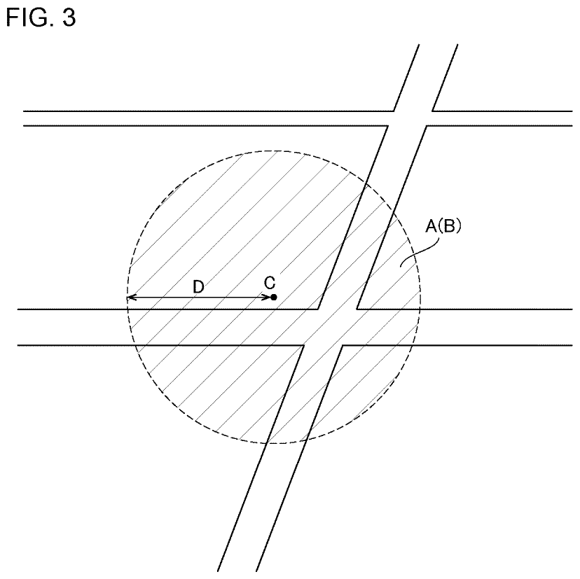

Then, as illustrated in FIG. 3, the estimation unit 13 estimates an area B within the estimated moving distance D from the installation position of the camera C specified by the camera identification unit 12 as an area A where the person to be tracked is present at the target time.

### Second Area Estimation Processing

The second area estimation processing is suitable for use in a case where two or more cameras are specified by the camera identification unit 12. For example, in a case where the predetermined condition is Condition 2 or Condition 3, two cameras may be specified. In a case where the predetermined condition is Condition 4, two or more cameras can be specified.

The estimation unit 13 calculates the moving time for each specified camera by processing similar to the processing described in the first area estimation processing. The estimation unit 13 calculates the estimated moving speed as a common value to be applied to all the cameras by processing similar to the processing described in the first area estimation processing. Then, the estimation unit 13 calculates the estimated moving distance for each specified camera by processing similar to the processing described in the first area estimation processing.

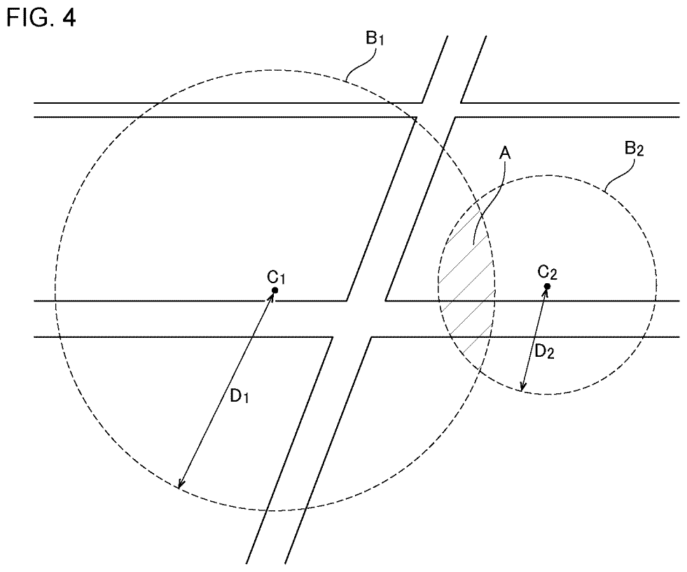

Then, as illustrated in FIG. 4, the estimation unit 13 specifies an area within the estimated moving distance from the installation position of the camera for each camera specified by the camera identification unit 12. FIG. 4 illustrates an example in which two cameras C₁ and C₂ are specified by the camera identification unit 12. Then, an area B₁ within the estimated moving distance D₁ from the installation position of the camera C₁ and an area B₂ within the estimated moving distance D₂ from the installation position of the camera C₂ are illustrated. The estimation unit 13 estimates an overlapping area of the area B₁ and the area B₂ as an area A where the person to be tracked is present at the target time. In a case where M (M is an integer of 2 or more) cameras are specified by the camera identification unit 12, the estimation unit 13 can estimate an area where all of the M areas B₁ to Bₘ overlap as the area A where the person to be tracked is present at the target time.

Third area estimation processing

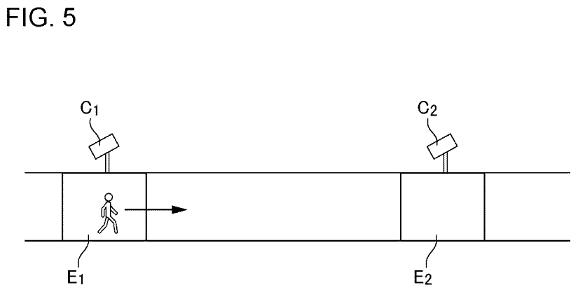

In the third area estimation processing, the estimation unit 13 determines whether the following three conditions described with reference to FIG. 5 are satisfied.
The target time is the current time.
As illustrated in FIG. 5, the camera C₁ specified by the camera identification unit 12 is installed on a one-lane road.
The person to be tracked is not detected in the image generated by another camera C₂ after the latest detection timing at which the person to be tracked is detected in the image generated by the camera C₁. The other camera C₂ is a camera installed ahead in the moving direction (direction indicated by an arrow in the drawing) on a one-lane road of the person to be tracked specified based on the image generated by the camera C₁.

In a case where all of the above three conditions are satisfied, the estimation unit 13 estimates an area between an imaging area E₁ of the camera C₁ identified by the camera identification unit 12 and an imaging area E₂ of the other camera C₂ as an area where the person to be tracked is present at the target time.

The “one-lane road” is a road having no branch. The one-lane road may be a road, or may be a corridor or a passage in a facility. In advance, map information indicating a one-lane road in an identifiable manner, a floor map of a facility, and the like are registered in the estimation device 10. The estimation unit 13 can specify whether each road is a one-lane road based on the information.

The “moving direction of the person to be tracked on the one-lane road” can be specified using any technique based on the moving direction of the person to be tracked in the image, and the like.

The “other camera C₂ installed ahead in the moving direction” can be specified based on information indicating the installation position of the camera registered in advance, the map information described above, the floor map of the facility, and the like.

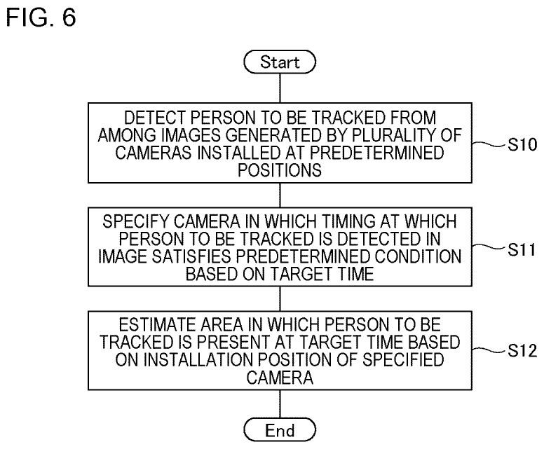

Next, an example of a flow of processing of the estimation device 10 will be described with reference to a flowchart of FIG. 6.

First, the estimation device 10 executes processing of detecting a person to be tracked from among images generated by a plurality of cameras installed at predetermined positions (S10). Next, the estimation device 10 specifies a camera in which the timing at which the person to be tracked is detected in the image satisfies a predetermined condition based on the target time (S11). Next, the estimation device 10 estimates an area in which the person to be tracked is present at the target time based on the installation position of the camera specified in S11 (S12). In a case where no camera is specified in S11, the estimation device 10 can end the processing without executing S12.

Although not illustrated, the estimation device 10 can output an estimation result. The estimation device 10 can output an estimation result via an output device such as a display or a projection device. For example, as illustrated in FIGS. 3 and 4, the estimation device 10 may output, as an estimation result, information indicating an area A in which it is estimated that the person to be tracked is present at the target time on a map (alternatively, on the floor map of the facility). The estimation device 10 may output information indicating the installation position of the camera specified by the camera identification unit 12, the above-described latest detection timing, and the like as attached information of the estimation result. Furthermore, the estimation device 10 may output the estimated moving speed and the estimated moving distance described above as attached information of the estimation result.

### “Operations and Effects”

The estimation device 10 of the present example embodiment specifies a camera that has detected the person to be tracked at a timing close to the target time, and estimates an area in which the person to be tracked is present at the target time based on the installation position of the camera and the estimated moving speed of the person to be tracked. According to such an estimation device 10, even if the person to be tracked is not shown in the image captured at the target time, the area in which the person to be tracked is present at the target time can be estimated. In the case of the present example embodiment, even if the capturing areas of the plurality of cameras do not overlap each other and there is a portion that is not captured by any camera, it is possible to estimate the area where the person to be tracked is present at the target time.

### Third Example Embodiment

The estimation device 10 of the present example embodiment includes a means for estimating a visit target of the person to be tracked in a facility present in an area where the person to be tracked is estimated to be present. Details will be described below.

The estimation unit 13 estimates an area in which the person to be tracked is present at the target time by the method described in the first and second example embodiments. Then, the estimation unit 13 estimates a visit target of the person to be tracked in the facilities present in the estimated area based on at least one of the clothing, belongings, age, sex, companion, movement means, movement route, and target time of the person to be tracked. The number of facilities estimated as visit targets may be one or more.

Clothing, belongings, age, sex, companion, movement means, and movement route of the person to be tracked are specified by user input or analysis of an image generated by a camera.

The “clothing” indicates its type. For example, it is an exercise wear, a smart wear, a casual wear, a suit, and the like. There are various means for specifying the type of clothing by image analysis. For example, the above classification can be performed based on the brand of clothing, characteristics of design and shape, and the like. For example, the classification may be achieved using a classifier generated by machine learning, or other means may be adopted.

The “belongings” indicates the type thereof. Examples thereof include sporting goods, business bags, and shopping bags. There are various means for specifying the type of belongings by image analysis. For example, the above classification can be performed based on characteristics of the appearance and the like. For example, the classification may be achieved using a classifier generated by machine learning, or other means may be adopted.

The “companion” indicates the presence or absence of a companion and the age and sex of the companion.

The “movement means” is walking, a bicycle, a motorcycle, an automobile, or the like.

The “movement route” is specified based on detection results by a plurality of cameras.

Next, an example of processing of estimating a visit target of a person to be tracked in a facility present in the estimated area will be described. The estimation unit 13 can execute at least one of the following first to fourth facility estimation processing.

### First Facility Estimation Processing

First, the estimation unit 13 specifies a facility present in the estimated area based on map information, a floor map of the facility, and the like registered in the estimation device 10 in advance. Examples of the facilities whose positions are indicated by map information, a floor map of the facilities, and the like include parks, supermarkets, department stores, hospitals, and the like. Examples of facilities provided in a facility include a kid's corner, a nursing room, a diaper changing room, and an exercise facility. The examples here are merely examples, and the present invention is not limited thereto.

The characteristic information of each of the plurality of facilities is registered in the estimation device 10 in advance. In the characteristic information of the facility, the use of each facility, the characteristic of the person who uses each facility, and the use time of each facility are indicated. Applications of each facility are exercise, shopping, play, and the like. The characteristics of the person who uses each facility are indicated by clothing, belongings, age, sex, movement means, and the like.

For example, the estimation unit 13 can estimate a purpose of the person to be tracked from clothing or belongings of the person to be tracked and estimate a facility matching the purpose as a visit target of the person to be tracked. For example, information in which the types of clothing and belongings are associated with the purpose may be registered in the estimation device 10 in advance. Then, the estimation unit 13 may estimate the purpose of the person to be tracked based on the information.

### Second Facility Estimation Processing

For example, the estimation unit 13 can estimate a facility in which a similarity between a characteristic of a person who uses the facility and a characteristic of the person to be tracked is a reference value or more as a visit target of the person to be tracked. The similarity of the characteristics can be calculated using any technique. For example, the similarity may be calculated based on the number of items having matching values. In this case, the greater the number of items with matching values, the higher the similarity.

The characteristics of the person who uses the facility and the characteristics of the person to be tracked are as described in the first facility estimation processing. The items are items included in the characteristics of the person, and are, for example, clothing, belongings, age, sex, movement means, and the like. A plurality of values can be set for the characteristics of the person who uses the facility in association with each item. For example, facilities used by both men and women can be set for both men and women in association with sex. In such a case, “the characteristics of the person who uses the facility and the characteristics of the person to be tracked match” means that the characteristics of the person to be tracked are included in the characteristics of the person who uses the facility.

### Third Facility Estimation Processing

The estimation unit 13 can estimate a visit target of the person to be tracked based on the movement route.

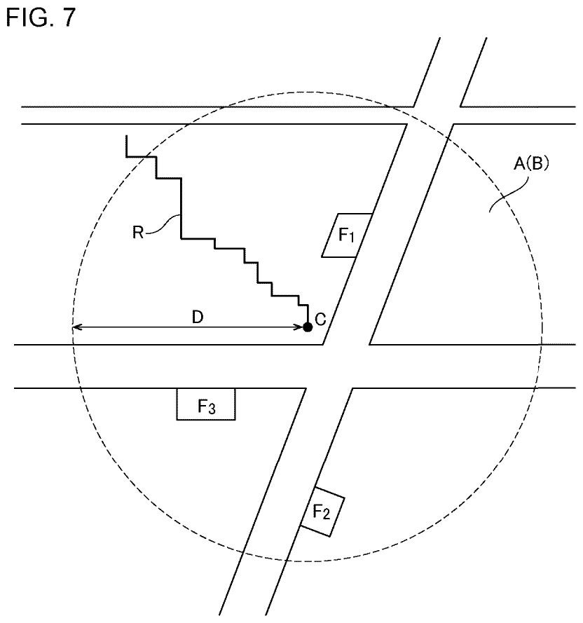

A specific example of the third facility estimation processing will be described with reference to FIG. 7. FIG. 7 illustrates a movement route R of the person to be tracked, an area A in which the person to be tracked is estimated to be present at the target time, and a plurality of facilities F₁ to F₃ present in the area A. In a case where the person to be tracked visits the facility F₁ or the facility F₃, the person to be tracked makes a detour to reach the facility. On the other hand, in a case where the person to be tracked visits the facility F₂, the person to be tracked arrives at the facility on the shortest route.

The possibility that the person takes a detour is low, and it is usually considered that the person goes to the target facility by the shortest route. Therefore, in the case of the example illustrated in FIG. 7, the estimation unit 13 estimates the facility F₂ as a visit target of the person to be tracked. The estimation unit 13 specifies a facility to be reached by the shortest route based on the movement route of the person to be tracked and the positional relationship with each of the plurality of facilities. Then, the estimation unit 13 estimates the specified facility as a visit target of the person to be tracked.

There are various means for specifying whether the arrival at each facility is the shortest route or a detour route. For example, the shortest route can be specified by a route search with an arbitrary position on the movement route R of the person to be tracked as a departure point and each facility as a destination point. Then, if the deviation from the same route as the shortest route calculated by the route search or the shortest route calculated by the route search is within a reference value, it may be determined as the shortest route, and if these conditions are not satisfied, it may be determined as the detour route. The above processing may be performed a plurality of times by changing the departure point to another position on the movement route R. Then, a facility determined to be the shortest route in any case or determined to be the shortest route a predetermined number of times or more may be estimated as a visit target of the person to be tracked.

The deviation from the shortest route calculated by the route search is indicated by a difference in distance between the first route and the second route or a difference in time required for movement. As the difference increases, the deviation from the shortest route increases. The first route is the “shortest route calculated by the route search”. The second route is a route on which “the departure point and the destination point is the same as the first route, and the person to be tracked moves to the end point indicated by the movement route R, and then moves from the end point to the destination point along the shortest route calculated by the route search”.

### Fourth Facility Estimation Processing

The estimation unit 13 can exclude a facility whose target time is not within the use time from a visit target of a person to be tracked. For example, the estimation unit 13 may estimate a facility remaining without being excluded as a visit target of the person to be tracked. In addition, the estimation unit 13 may estimate the visit target of the person to be tracked from among the facilities remaining without being excluded using any of the first to third facility estimation processing described above.

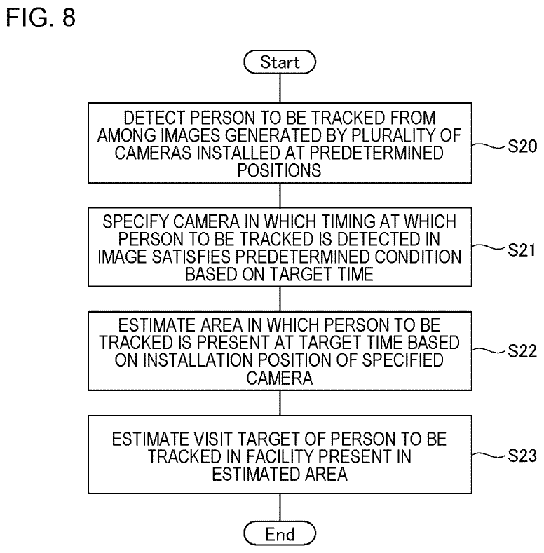

Next, an example of a flow of processing of the estimation device 10 will be described with reference to a flowchart of FIG. 8.

First, the estimation device 10 executes processing of detecting a person to be tracked from among images generated by a plurality of cameras installed at predetermined positions (S20). Next, the estimation device 10 specifies a camera in which the timing at which the person to be tracked is detected in the image satisfies a predetermined condition based on the target time (S21). Next, the estimation device 10 estimates an area in which the person to be tracked is present at the target time based on the installation position of the camera specified in S21 (S22). Thereafter, the estimation device 10 estimates a visit target of the person to be tracked in the facility present in the area estimated in S22 (S23). In a case where no camera is specified in S21, the estimation device 10 can end the processing without executing S22 and S23.

Although not illustrated, the estimation device 10 can output an estimation result. The estimation device 10 can output an estimation result via an output device such as a display or a projection device. For example, as illustrated in FIGS. 3 and 4, the estimation device 10 may output, as an estimation result, information indicating an area A in which it is estimated that the person to be tracked is present at the target time on a map (alternatively, on the floor map of the facility). The estimation device 10 may highlight a facility estimated to be a visit target of the person to be tracked on the map (alternatively, on the floor map of the facility). The estimation device 10 may output information indicating the installation position of the camera specified by the camera identification unit 12, the above-described latest detection timing, and the like as attached information of the estimation result. Furthermore, the estimation device 10 may output the estimated moving speed and the estimated moving distance described above as attached information of the estimation result.

Other configurations of the estimation device 10 are similar to those of the first and second example embodiments.

With the estimation device 10 of the present example embodiment, operations and effects similar to those of the estimation device 10 of the first and second example embodiments are implemented. According to the estimation device 10 of the present example embodiment, it is possible to estimate a visit target (facility) of the person to be tracked based on at least one of clothing, belongings, age, sex, companion, vehicle, movement route, and target time of the person to be tracked.

### Modifications

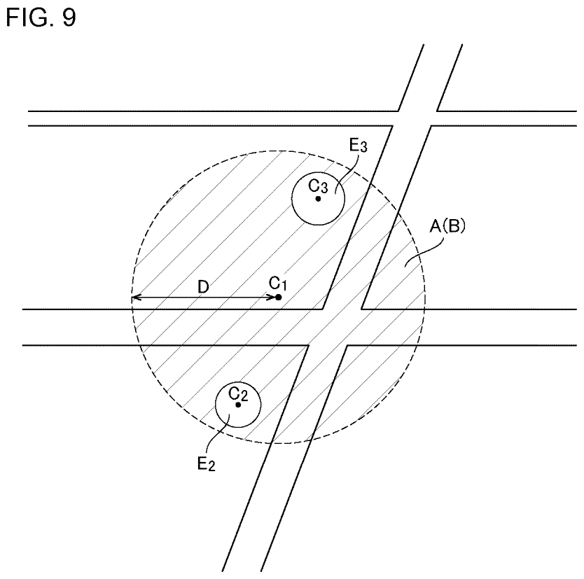

As illustrated in FIG. 9, the estimation device 10 can output information indicating the imaging areas E₂ and E₃ of the predetermined cameras C₂ and C₃ present in the area A in which the person to be tracked is estimated to be present at the target time. The predetermined cameras C₂ and C₃ are cameras not specified by the camera identification unit 12. That is, the predetermined cameras C₂ and C₃ are cameras that do not satisfy the predetermined condition described in detail in the second example embodiment. The imaging areas E₂ and E₃ of the predetermined cameras C₂ and C₃ can be excluded from the candidates of the area where the person to be tracked is present at the target time. The user can grasp the area where the person to be tracked is present at the target time based on the information as illustrated in FIG. 9.

Although the example embodiments of the present invention have been described above with reference to the drawings, these are examples of the present invention, and various configurations other than the above can be used. The configurations of the above-described example embodiments may be combined with each other, or some configurations may be replaced with other configurations. Various modifications may be made to the configurations of the above-described example embodiments within a range not departing from the gist. The configurations and processing disclosed in the above-described example embodiments and modifications may be combined with each other.

In the plurality of flowcharts used in the above description, a plurality of steps (processing) are described in order. However, the execution order of the steps executed in each example embodiment is not limited to the described order. In each example embodiment, the order of the illustrated steps can be changed within a range in which there is no problem in terms of contents. The above-described example embodiments can be combined within a range in which the contents are not contradictory.

Some or all of the above example embodiments may be described as the following supplementary notes, but are not limited to the following.

1. An estimation device including:
a person detection means for detecting a person to be tracked from among images generated by a plurality of cameras installed at predetermined positions;
a camera identification means for specifying the camera in which a timing at which the person to be tracked is detected in the image satisfies a predetermined condition based on a target time; and
an estimation means for estimating an area where the person to be tracked is present at the target time based on a specified installation position of the camera.

2. The estimation device according to 1, in which the predetermined condition includes at least one of:
a condition that the person to be tracked is detected at a timing closest to the target time among the plurality of cameras;
a condition that the person to be tracked is detected at a timing closest to the target time among the plurality of cameras before the target time;
a condition that the person to be tracked is detected at a timing closest to the target time among the plurality of cameras after the target time; and
a condition that the person to be tracked is detected within a reference time from the target time.

3. The estimation device according to 1 or 2, in which the target time is a current time or a current, future, or past time designated by a user.

4. The estimation device according to any one of 1 to 3, in which the estimation means is configured to execute:
calculating an estimated moving distance of the person to be tracked between a latest detection timing and the target time based on a time difference between the latest detection timing at which the person to be tracked is detected in an image generated by the specified camera and the target time and an estimated moving speed of the person to be tracked; and
estimating an area within the estimated moving distance from the specified installation position of the camera as an area where the person to be tracked is present at the target time.

5. The estimation device according to 4, in which
the estimation means is configured to execute:
estimating an overlapping area of an area within the estimated moving distance from an installation position of the camera where the person to be tracked is detected at a timing closest to the target time before the target time and an area within the estimated moving distance from an installation position of the camera where the person to be tracked is detected at a timing closest to the target time after the target time as an area where the person to be tracked is present at the target time.

6. The estimation device according to 4 or 5, in which
the estimation means is configured to execute:
determining the estimated moving speed based on a characteristic of the person to be tracked acquired by user input or analysis of an image generated by the camera.

7. The estimation device according to 6, in which the characteristic of the person to be tracked includes at least one of an age, a sex, presence or absence of baggage, a size of baggage, presence or absence of injury, a movement means, and a moving speed in an image of the person to be tracked.

8. The estimation device according to any one of 1 to 7, in which the estimation means is configured to execute:
in a case where the target time is a current time, the specified camera is installed on a one-lane road, and after the person to be tracked is detected in an image generated by the specified camera, the person to be tracked is not detected in an image generated by another specified camera installed ahead in the moving direction of the person to be tracked based on an image generated by the specified camera,
estimating an area between the specified camera and the other specified camera as an area where the person to be tracked is present at the target time.

9. The estimation device according to any one of 1 to 8, in which the estimation means is configured to execute:
estimating a visit target of the person to be tracked in a facility present in an area where the person to be tracked is estimated to be present at the target time based on at least one of clothing, belongings, age, sex, a companion, a movement means, a movement route, and the target time of the person to be tracked.

10. An estimation method for causing one or more computers to execute:
detecting a person to be tracked from among images generated by a plurality of cameras installed at predetermined positions;
specifying the camera in which a timing at which the person to be tracked is detected in the image satisfies a predetermined condition based on a target time; and
estimating an area where the person to be tracked is present at the target time based on a specified installation position of the camera.

11. A program for causing a computer to function as:
a person detection means for detecting a person to be tracked from among images generated by a plurality of cameras installed at predetermined positions;
a camera identification means for specifying the camera in which a timing at which the person to be tracked is detected in the image satisfies a predetermined condition based on a target time; and
an estimation means for estimating an area where the person to be tracked is present at the target time based on a specified installation position of the camera.

This application is based upon and claims the benefit of priority from Japanese patent application No. 2023-041791, filed on Mar. 16, 2023, the disclosure of which is incorporated herein in its entirety by reference.

### REFERENCE SIGNS LIST

10 estimation device
11 person detection unit
12 camera identification unit
13 estimation unit
1A processor
2A memory
3A input/output I/F
4A peripheral circuit
5A bus

What is claimed is:

1. An estimation apparatus comprising:
at least one memory configured to store one or more instructions; and
at least one processor configured to execute the one or more instructions to:
detect a person to be tracked from among images generated by a plurality of cameras installed at predetermined positions;
specify the camera in which a timing at which the person to be tracked is detected in the image satisfies a predetermined condition based on a target time; and
estimate an area where the person to be tracked is present at the target time based on a specified installation position of the camera.

2. The estimation apparatus according to claim 1, wherein
the predetermined condition includes at least one of:
a condition that the person to be tracked is detected at a timing closest to the target time among the plurality of cameras;
a condition that the person to be tracked is detected at a timing closest to the target time among the plurality of cameras before the target time;
a condition that the person to be tracked is detected at a timing closest to the target time among the plurality of cameras after the target time; and
a condition that the person to be tracked is detected within a reference time from the target time.

3. The estimation apparatus according to claim 1 or 2, wherein the target time is a current time or a current, future, or past time designated by a user.

4. The estimation apparatus according to claim 1, wherein
the at least one processor is further configured to execute the one or more instructions to:
calculate an estimated moving distance of the person to be tracked between a latest detection timing and the target time based on a time difference between the latest detection timing at which the person to be tracked is detected in an image generated by the specified camera and the target time and an estimated moving speed of the person to be tracked; and
estimate an area within the estimated moving distance from the specified installation position of the camera as an area where the person to be tracked is present at the target time.

5. The estimation apparatus according to claim 4, wherein the at least one processor is
further configured to execute the one or more instructions to:
estimate an overlapping area of an area within the estimated moving distance from an installation position of the camera where the person to be tracked is detected at a timing closest to the target time before the target time and an area within the estimated moving distance from an installation position of the camera where the person to be tracked is detected at a timing closest to the target time after the target time as an area where the person to be tracked is present at the target time.

6. The estimation apparatus according to claim 4, wherein
the at least one processor is further configured to execute the one or more instructions to:
determine the estimated moving speed based on a characteristic of the person to be tracked acquired by user input or analysis of an image generated by the camera.

7. The estimation apparatus according to claim 6, wherein the characteristic of the person to be tracked includes at least one of an age, a sex, presence or absence of baggage, a size of baggage, presence or absence of injury, a movement means, and a moving speed in an image of the person to be tracked.

8. The estimation apparatus according to claim 1, wherein the at least one processor is further configured to execute the one or more instructions to:
in a case where the target time is a current time, the specified camera is installed on a one-lane road, and after the person to be tracked is detected in an image generated by the specified camera, the person to be tracked is not detected in an image generated by another specified camera installed ahead in the moving direction of the person to be tracked based on an image generated by the specified camera,
estimate an area between the specified camera and the other specified camera as an area where the person to be tracked is present at the target time.

9. The estimation apparatus according to claim 1, wherein
the at least one processor is further configured to execute the one or more instructions to:
estimate a visit target of the person to be tracked in a facility present in an area where the person to be tracked is estimated to be present at the target time based on at least one of clothing, belongings, age, sex, a companion, a movement means, a movement route, and the target time of the person to be tracked.

10. An estimation method for causing one or more computers to execute:
detecting a person to be tracked from among images generated by a plurality of cameras installed at predetermined positions;
specifying the camera in which a timing at which the person to be tracked is detected in the image satisfies a predetermined condition based on a target time; and
estimating an area where the person to be tracked is present at the target time based on a specified installation position of the camera.

11. The estimation method according to claim 10, wherein
the predetermined condition includes at least one of:
a condition that the person to be tracked is detected at a timing closest to the target time among the plurality of cameras;
a condition that the person to be tracked is detected at a timing closest to the target time among the plurality of cameras before the target time;
a condition that the person to be tracked is detected at a timing closest to the target time among the plurality of cameras after the target time; and
a condition that the person to be tracked is detected within a reference time from the target time.

12. The estimation method according to claim 10, wherein the target time is a current time or a current, future, or past time designated by a user.

13. The estimation method according to claim 10, wherein the one or more computers execute:
calculating an estimated moving distance of the person to be tracked between a latest detection timing and the target time based on a time difference between the latest detection timing at which the person to be tracked is detected in an image generated by the specified camera and the target time and an estimated moving speed of the person to be tracked; and
estimating an area within the estimated moving distance from the specified installation position of the camera as an area where the person to be tracked is present at the target time.

14. The estimation method according to claim 13, wherein
the one or more computers execute:
estimating an overlapping area of an area within the estimated moving distance from an installation position of the camera where the person to be tracked is detected at a timing closest to the target time before the target time and an area within the estimated moving distance from an installation position of the camera where the person to be tracked is detected at a timing closest to the target time after the target time as an area where the person to be tracked is present at the target time.

15. The estimation method according to claim 13, wherein
the one or more computers execute:
determining the estimated moving speed based on a characteristic of the person to be tracked acquired by user input or analysis of an image generated by the camera.

16. A non-transitory computer-readable medium having recorded therein a program for causing a computer to:
detect a person to be tracked from among images generated by a plurality of cameras installed at predetermined positions;
specify the camera in which a timing at which the person to be tracked is detected in the image satisfies a predetermined condition based on a target time; and
estimate an area where the person to be tracked is present at the target time based on a specified installation position of the camera.

17. The recording non-transitory computer-readable medium according to claim 16, wherein
the predetermined condition includes at least one of:
a condition that the person to be tracked is detected at a timing closest to the target time among the plurality of cameras;
a condition that the person to be tracked is detected at a timing closest to the target time among the plurality of cameras before the target time;
a condition that the person to be tracked is detected at a timing closest to the target time among the plurality of cameras after the target time; and
a condition that the person to be tracked is detected within a reference time from the target time.

18. The recording non-transitory computer-readable medium according to claim 16, wherein the target time is a current time or a current, future, or past time designated by a user.

19. The non-transitory computer-readable medium according to claim 16, wherein the program causes the computer to:
calculate an estimated moving distance of the person to be tracked between a latest detection timing and the target time based on a time difference between the latest detection timing at which the person to be tracked is detected in an image generated by the specified camera and the target time and an estimated moving speed of the person to be tracked; and
estimate an area within the estimated moving distance from the specified installation position of the camera as an area where the person to be tracked is present at the target time.

20. The non-transitory computer-readable medium according to claim 19, wherein
the program causes the computer to:
estimate an overlapping area of an area within the estimated moving distance from an installation position of the camera where the person to be tracked is detected at a timing closest to the target time before the target time and an area within the estimated moving distance from an installation position of the camera where the person to be tracked is detected at a timing closest to the target time after the target time as an area where the person to be tracked is present at the target time.
